(19) United States
(12) Patent Application Publication
(10) Pub. No.: US 2019/0391107 A1
(43) Pub. Date: Dec. 26, 2019

(54) GAS SENSOR, METHOD FOR MANUFACTURING THE SAME, AND METHOD FOR SENSING GAS USING THE SAME

(71) Applicants: Hyundai Motor Company, Seoul (KR); Kia Motors Corporation, Seoul (KR); Industry-University Cooperation Foundation Of Seokyeong University, Seoul (KR)

(72) Inventors: Jin Hyeok Cha, Suwon (KR); Kyong Hwa Song, Yongin (KR); Jong Hoon Kim, Seoul (KR)

(73) Assignees: Hyundai Motor Company; Kia Motors Corporation; Industry-University Cooperation Foundation Of Seokyeong University

(21) Appl. No.: 16/198,222

(22) Filed: Nov. 21, 2018

(30) Foreign Application Priority Data
Jun. 21, 2018 (KR) 10-2018-0071584

(51) Int. Cl. G01N 27/403; G01N 27/30

(52) U.S. Cl. CPC G01N 27/403; G01N 27/308

(57) ABSTRACT

A gas sensor includes a positive electrode of a carbon material and a negative electrode. The gas sensor further includes an insulation substrate, where the positive electrode and the negative electrode are attached to the insulation substrate, and surfaces of the positive electrode and the negative electrode and a surface of a portion of the insulation substrate between the positive electrode and the negative electrode are coated with a hygroscopic salt. The gas sensor may maintain moisture on the surface of the sensor electrode without using a separate external moisture supply device and may sense a gas with a high sensitivity even without using a high-priced catalyst metal or a high-temperature reaction.

### CROSS-REFERENCE TO RELATED APPLICATION

This application claims under 35 U.S.C. § 119(a) the benefit of Korean Patent Application No. 10-2018-0071584, filed on Jun. 21, 2018 in the Korean Intellectual Property Office, the entire contents of which are incorporated by reference herein.

### BACKGROUND

### (a) Technical Field

The present disclosure relates to a gas sensor, more particularly, to the gas sensor including a positive electrode and a negative electrode of a carbon material.

### (b) Description of the Related Art

Currently, various types of electrochemical sensors are being developed and used. For example, glucose sensors may be operated at room temperature, implemented in various applications, and have low production costs, and thus typically are successful commercially.

Generally, an electrochemical sensor corresponds to a 3-electrode system, and in particular, includes a working electrode that functions as a sensor, a counter electrode that functions as a ground of a circuit while generating a counter reaction to that of the working electrode, and a reference electrode that generates a standard reaction voltage.

Electrochemical sensors have been developed as liquid sensors that measure reactions based on a solution, and measure a change of current density of a charge generated on a surface of an electrode by an oxidation/reduction pair reaction. Because the electrochemical sensor generates flows of charges, it requires an electrolyte that is suitable for delivering the generated charges; and blood, water, or a conductive organic solvent are generally used as the electrolyte.

Meanwhile, commercially-available gas sensors typically include a separate fan for condensing a gas that is a sensing target material, the electric power supplied to drive the fan is 100 mA or higher, and the electric power is several times that used to drive a micro controller unit (MCU) and the sensor itself and causes continuous energy consumption.

Further, a separate condensation apparatus is required for condensing the sensing target material on the gas, where it is difficult to shorten a gas sensing time that typically lasts from 30 seconds to 10 minutes if the gas is not condensed by using the condensation apparatus.

Further, it is difficult to measure a gas reaction unless a strong oxidizing agent such as sulfuric acid is applied as an electrolyte to the electrochemical sensor at room temperature, and it is considered that the measurement of the gas reaction is almost impossible unless a high-priced catalyst metal or a high temperature reaction is used.

Efforts for improving sensitivity and reaction speed as compared with those of existing sensors by manufacturing gas sensors based on nano structures having wide surface areas recently have been made. However, the surface of the sensor must be humid in order that the gas molecules are adsorbed to the surface of the sensor, and due to the natural lotus effect of the nano structure (see, e.g., FIG. 2), the nano structure shows a high hydrophobicity and the sensing capability deteriorates. Even when a liquid is supplied from the outside to solve the above-mentioned problems, the effect of making the surface of the nano structure humid deteriorates and in fact, the sensing target material has been blocked from being diffused to the entire surface of the sensor.

### SUMMARY

The present disclosure provides a gas sensor that may be implemented with a high sensitivity without using a strong oxidizing agent and without using a high-priced catalyst metal and a high-temperature reaction.

The present disclosure also provides a gas sensor that makes a surface of the gas sensor humid and has an excellent gas sensing sensitivity even without using a separate gas condensing apparatus and a liquid supply apparatus.

The present disclosure provides a gas sensor including an insulation substrate, and a positive electrode and a negative electrode attached to the insulation substrate, wherein surfaces of the positive electrode and the negative electrode and a surface of a portion of the insulation substrate between the positive electrode and the negative electrode on the insulation substrate are coated with hygroscopic salt.

The present disclosure also provides a gas sensing method for sensing a sensing target gas by using the gas sensor.

The gas sensor according to the present disclosure may have low impedance between electrodes within the sensor, maintain moisture on the surface of the sensor electrodes without using a separate moisture-providing part, and be implemented excellently with a high sensitivity without using a strong oxidizing agent and without using a high-priced catalyst metal and a high-temperature reaction.

### BRIEF DESCRIPTION OF THE DRAWINGS

The above and other objects, features and advantages of the present disclosure will be more apparent from the following detailed description taken in conjunction with the accompanying drawings:

FIG. 1 is a diagram according to an embodiment of a gas sensor according to the present disclosure.

FIG. 2 is a diagram illustrating hydrophobicity by a lotus effect of a nano structure.

FIG. 3 is a picture of a carbon nano tube core and a p type nano diamond shell nano structure manufactured according to an embodiment of the present disclosure.

FIG. 4 illustrates a graph of results obtained by sensing glucose molecules by using the gas sensor manufactured according to an embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, the present disclosure will be described in detail.

The present disclosure provides a gas sensor, a method for manufacturing the gas sensor, and a gas sensing method for sensing a sensing target gas by using the gas sensor.

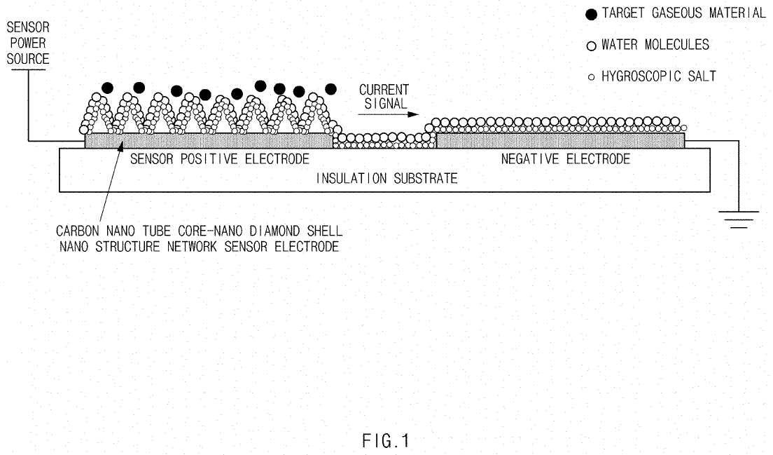

FIG. 1 is a diagram according to an embodiment of a gas sensor according to the present disclosure. The gas sensor illustrated in FIG. 1 includes a positive electrode and a negative electrode attached to an insulation substrate, and it is illustrated that surfaces of the positive electrode and the negative electrode and a surface of a portion of the substrate between the positive electrode and the negative electrode are coated with a hygroscopic salt and water molecules attached to the hygroscopic salt form a moisture film on the surface of the electrodes. Further, it is illustrated that the positive electrode has a carbon nano tube core-nano diamond shell structure, and the gas sensor may be connected to a sensor electrode and an external voltage.

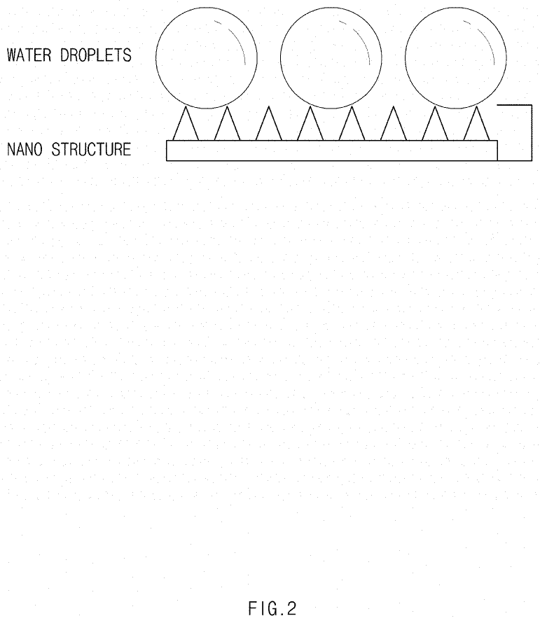

FIG. 2 is a diagram illustrating hydrophobicity by a lotus effect of a nano structure.

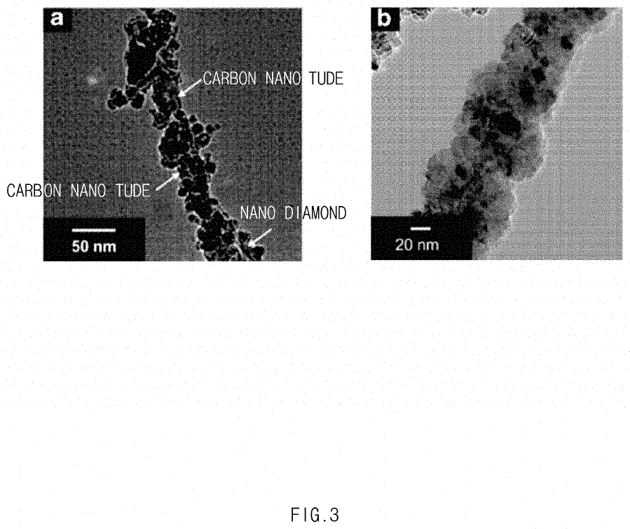

FIG. 3 is a picture of a IBM (production model: TitanTM80-300, manufacturer: FEI) of a carbon nano tube core and a p type nano diamond shell nano structure manufactured according to an embodiment of the present disclosure. FIG. 3 (left picture labeled “a”) illustrates that nano diamond nuclei are grown on a surface of a carbon nano tube stem, and FIG. 3 (right picture labeled “b”) illustrates that nano diamond nudeui are self-assembled to form a nano structure of a carbon nano tube core and a nano diamond shell while covering a surface of a carbon nano tube. The average diameter of the nano structure is 80 nm.

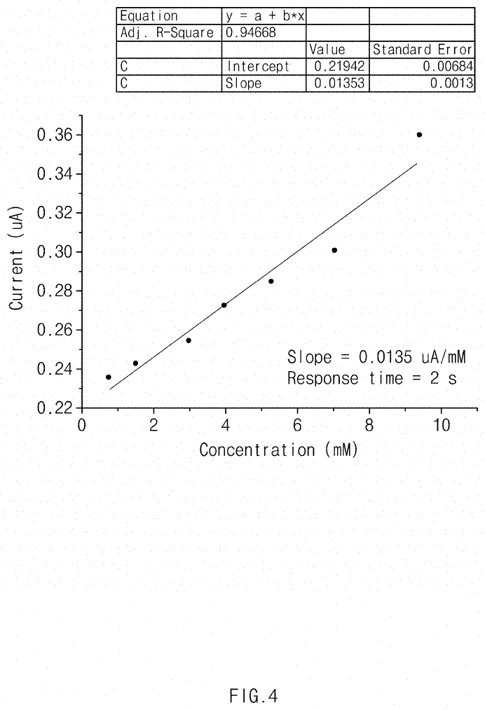

FIG. 4 illustrates a graph of results obtained by sensing glucose molecules by using the gas sensor manufactured according to an embodiment of the present disclosure. The left side illustrates a sensing result for a high concentration (910 mMol or more) area and the right side illustrates a low concentration (5 mMol or less) area. It can be identified that the sensing result shows a sensitivity that is less than 100 times as high as those of the existing enzyme based sensors.

The equation of the graph may be represented by y−a+b*x, an Adj. R-Square value is 0.94668, an intercept constant value is 0.0.21942, a standard error is 0.00684, a slope constant value is 0.01353, and a standard error is 0.0013.

<Gas Sensor>

In particular, the present disclosure provides a gas sensor including an insulation substrate, and a positive electrode and a negative electrode attached to the insulation substrate, wherein surfaces of the positive electrode and the negative electrode and a surface of a portion of the insulation substrate between the positive electrode and the negative electrode on the insulation substrate are coated with hygroscopic salt

<Hygroscopic Salt>

In the gas sensor of the present disclosure, surfaces of a positive electrode and a negative electrode and a surface of a portion of an insulation substrate between the positive electrode and the negative electrode on the insulation substrate are coated with a hygroscopic salt.

In the present disclosure, the term ‘hygroscopic’ refers to a property of absorbing moisture in the air. In the specification of the present disclosure, the term ‘a hygroscopic salt’ refers to a salt having a property of absorbing moisture in the air.

The present disclosure may decrease a temperature dependency of a sensor and improve sensing sensitivity by using a gas sensor in which surfaces of a positive electrode and a negative electrode and a surface of a portion of an insulation substrate between the positive electrode and the negative electrode on the insulation substrate are coated with a hygroscopic salt.

According to the present disclosure, ‘the hygroscopic salt’ is not limited but for example, may include a hydroxide, a chloride, a bromide, a nitrate, a carbonate, a sulfate, an acetate, or a mixture thereof, in more detail, may include sodium hydroxide, potassium hydroxide, iron hydroxide, sodium chloride, potassium chloride, calcium chloride, zinc chloride, lithium chloride, sodium bromide, lithium bromide, potassium carbonate, calcium carbonate, potassium sulfate, sodium acetate, potassium acetate, ammonium acetate, or a mixture thereof, preferably, may include sodium hydroxide, potassium hydroxide, iron hydroxide, calcium chloride, zinc chloride, or a mixture thereof, more preferably, may include a hydroxide, such as sodium hydroxide, potassium hydroxide, or iron hydroxide, and most preferably, may include sodium hydroxide.

According to the present disclosure, surfaces of the positive electrode and the negative electrode and a surface of a portion of the insulation substrate between the positive electrode and the negative electrode on the insulation substrate are coated with hygroscopic salt.

In the gas sensor according to the present disclosure, by coating the surfaces of the positive electrode, the negative electrode, and the insulation substrate with the hygroscopic salt, the hygroscopic salt may adsorb surrounding moisture to a sensor and the moisture adsorbed to the sensor forms a moisture film. The formed moisture film may shows an effect of improving the sensitivity of the sensor by amplifying a signal even only with a gas of a low concentration, a system that represents a high sensitivity of the gas sensor according to the present disclosure is not limited thereto.

According to the present disclosure, the ‘coating’ may be performed through a method of supporting an insulation substrate, to which the positive electrode and the negative electrode are attached, in a coating solution including a hygroscopic salt and then drying the insulation substrate, or a method, such as spraying. Preferably, the method of supporting an insulation substrate in a coating solution and then drying the insulation substrate may be performed, the present disclosure is not limited thereto.

In an embodiment, in the gas sensor according to the present disclosure, the coating of the hygroscopic salt may be identified through an increase of a roughness of a surface of the insulation substrate. In a detailed embodiment, it was identified that the roughness of the substrate was Ra-10 nm before the hygroscopic salt is coated and the roughness of the substrate was Ra=100 nm after the hygroscopic salt is coated.

<Positive Electrode>

In the gas sensor according to the present disclosure, the positive electrode may be an electrode of a gold (Au)-based material, a platinum (Pt)-based material, a metal oxide material, or a carbon-based material.

In the present disclosure, the ‘gold (Au)-based material’ is a material of an electrode, which is generally used in the field to which the present disclosure pertains, and is a generic term for a material including only a gold (Au) material or an alloy including gold.

In the present disclosure, the ‘platinum (Pt)-based material’ is a material of an electrode, which is generally used in the field to which the present disclosure pertains, and is a generic term for a material including only a platinum (Pt) material or an alloy including platinum.

In the present disclosure, the ‘metal oxide material’ is a material of an electrode, which is generally used in the field to which the present disclosure pertains, and is a generic term for a metal oxide or a composition including a metal oxide. The metal oxide material of the present disclosure is not limited, but for example, may include RuO₂, Ni(OH)₂, MnO₂, PbO₂, TiO₂, or a mixture thereof.

In the present disclosure, the ‘carbon-based’ material is a material of an electrode, which is generally used in the art to which the present disclosure pertains and may include only carbon or a material including carbon of not less than 50 wt % of the total weight of the electrode, and for example, may include graphite felt, carbon cloth, reticulated vitrous carbon, fullerene, diamond, diamond like carbon, nano diamond, graphite fiber fabric, graphite particles, carbon nano tubes, carbon wires, carbon nano wires, and carbon fiber brushes.

Preferably, the positive electrode according to the present disclosure may include a core formed of a carbon-based material and a nano structure formed of a nano diamond shell, and more preferably, the carbon-based material forming the core may include carbon nano tubes, carbon wires, carbon nano wires, and carbon fiber brushes. Most preferably, the positive electrode may include a nano structure including a carbon nano tube and a nano diamond shell.

In an embodiment, the nano structure may be formed in a method of immersing the carbon nano tube in a solution in which nano diamond particles are dispersed to form carbon nano tubes in which the nano diamond particles are adsorbed on surfaces thereof and applying a static charge such that nano diamond may be self-assembled on the surfaces of the carbon nano tubes while the nano diamond particles are taken as deposition nuclei, the method of forming a nano structure of the carbon nano tube core and the nano diamond shell structure is not limited thereto.

Further, according to the present disclosure, the average diameter of the nano structure is not limited, but may be 0.1 nm to 20 nm, preferably, may be 1 nm to 10 nm, and more preferably, may be 3 nm to 5 nm.

In an embodiment, the average diameter of the nano structure including the carbon nano tube core and the nano diamond shell may be 10 nm to 500 nm, preferably, may be 20 nm to 200 nm, and more preferably, may be 50 nm to 100 nm. When the average diameter of the nano structure is within the above ranges, the gas sensor may be economical and the sensitivity of the gas sensor may be excellent.

In the positive electrode according to the present disclosure, the nano diamond may be n type doped or p type doped, and preferably, may be p type doped. The nano diamond may be p type doped to improve the implementation and stability of sensing.

The p type doping may be made by using one or more doping elements selected from group 3 elements of the periodic table, and preferably, may be made by using one or more doping elements selected from group 3 elements. More preferably, the doping elements are not limited, but for example, may include one or more elements selected from boron, aluminum, potassium, and indium, and most preferably, may include boron.

In the gas sensor according to the present disclosure, because the positive electrode includes a nano diamond shell doped with boron, a low impedance may be achieved, the life span of the electrode may be improved, the noise of the sensor may be lowered, and an excellent sensing sensitivity may be shown.

<Negative Electrode>

In the gas sensor according to the present disclosure, the negative electrode may be an electrode of a gold (Au)-based material, a platinum (Pt)-based material, a metal oxide material, or a carbon-based material.

In the present disclosure, the ‘platinum (Pt)-based material’ is a material of an electrode, which is generally used in the field to which the present disclosure pertains, and is a generic term for a material including only a platinum (Pt) material or an alloy including platinum.

In the present disclosure, the ‘metal oxide material’ is a material of an electrode, which is generally used in the field to which the present disclosure pertains, and is a generic term for a metal oxide or a composition including a metal oxide. The metal oxide material of the present disclosure is not limited, but for example, may include RuO₂, Ni(OH)₂, MnO₂, PbO₂, TiO₂, or a mixture thereof.

In the present disclosure, the ‘carbon-based’ material is a material of an electrode, which is generally used in the art to which the present disclosure pertains and may include only carbon or a material including carbon of not less than 50 wt % of the total weight of the electrode, and for example, may include graphite felt, carbon cloth, reticulated vitrous carbon, fullerene, diamond, diamond like carbon, nano diamond, graphite fiber fabric, graphite particles, carbon nano tubes, carbon wires, carbon nano wires, and carbon fiber brushes.

According to the present disclosure, preferably, the negative electrode may include an electrode of a carbon-based material such as carbon fiber.

In the gas sensor according to the present disclosure, because the surfaces of the positive electrode, the negative electrode, and the insulation substrate are coated with a hygroscopic salt, an excellent sensing sensitivity may be shown even when an electrode of a carbon material is used by improving the sensitivity of the sensor, for example, excellently amplifying a signal even for a gas of a low concentration.

<Insulation Substrate>

The gas sensor according to the present disclosure includes an insulation substrate on which a positive electrode and a negative electrode are disposed. The insulation substrate according to the present disclosure may include a general insulation substrate that is used for a sensor electrode or an electrode, and the material of the insulation substrate, for example, may include a metal oxide, such as a silicon oxide film, a sapphire substrate, or an alumina substrate, and a nitride, glass, polyethyleneterephthalate, polyethylene naphthalate, polycarbonate, polyethylene sulfite, acrylite, polyimide, or polynorbomene, but the present disclosure is not limited thereto.

According to the present disclosure, the positive electrode and the negative electrode are preferably attached to the same surface of the insulation substrate but may be attached to different surfaces of the insulation substrate, and the scope of the present disclosure is not limited to the form in which the positive electrode and the negative electrode are attached to the insulation substrate. Further, the attachment may be performed through a method that is well known in the art to which the present disclosure pertains and is not specifically limited thereto.

Further, the nano structure of the positive electrode on the insulation substrate may be formed by attaching the core of a carbon-based material to the insulation substrate and forming the nano diamond shell on a surface of the core, or the nano structure in which the nano diamond shell is formed on a surface of the core of the carbon-based material may be attached to the insulation substrate.

Further, according to the present disclosure, because a sensor signal (current) increases as an interval between the positive electrode and the negative electrode on the insulation substrate decreases and a signal corresponding to a voltage also increases due to attachment of a load resistor, it is preferable to allow a general technology of maintaining the interval within a range in which the fibers of the positive electrode and the negative electrode do not contact each other. When the fibers of the positive electrode and the negative electrode contact each other, the positive electrode and the negative electrode may be short-circuited.

<Method for Manufacturing Gas Sensor>

The present disclosure may provide a method for manufacturing the gas sensor.

The manufacturing method according to the present disclosure may include an operation of supporting the insulation substrate, to which the positive electrode and the negative electrode are attached, in a coating solution including a hygroscopic salt and then drying the insulation substrate.

In the method for manufacturing a gas sensor according to the present disclosure, the positive electrode, the negative electrode, the insulation substrate, and the hygroscopic salt may be the positive electrode, the negative electrode, the insulation substrate, and the hygroscopic salt, which are disclosed in the description of the gas sensor.

In particular, the concentration of the coating solution including the hygroscopic salt is not limited, but preferably, the concentration of the coating solution may be 1 nMol/L to 10 Mol/L while the hygroscopic salt is taken as a solute, more preferably, may be 1 mMol/L to 5 mol/L, and most preferably, may be 0.1 mol/L. A gas sensor having an excellent sensitivity may be manufactured when the concentration of the coating solution is within the concentration range, a performance of the electrode may become inferior because the sensitivity is weak or an improvement of the impedance of the flows of currents is low when the concentration of the coating solution is less than the concentration range, and the gas sensor may not be economical and the sensing sensitivity may decrease as the uniformity of the coating become lower when the concentration of the coating solution exceeds the concentration range.

In the ‘coating solution’ according to the present disclosure, the solvent of the coating solution is not limited but may include distilled water, ethyl alcohol, methyl alcohol, acetone, isopropyl alcohol, butyl alcohol, ethylene glycol, di-ethylene glycol, toluene, or a mixture thereof, and preferably, may include distilled water, ethyl alcohol, methyl alcohol, isopropyl alcohol, butyl alcohol, ethylene glycol, di-ethylene glycol, or a mixture thereof, and more preferably, may include distilled water.

In an embodiment, a gas sensor in which surfaces of a positive electrode and a negative electrode and a surface of a portion of an insulation substrate between the positive electrode and the negative electrode are coated with sodium hydroxide was manufactured by supporting the insulation substrate, to which the positive electrode and the negative electrode are attached, in a coating solution of sodium hydroxide of 0.1 mol/L in purified water and drying the insulation substrate.

In the ‘coating’ according to the present disclosure, the support time is not limited but preferably, may be 1 second to 60 minutes. When the support time is below the range, a total amount of the hygroscopic salt coated on a surface of the gas sensor and/or a uniformity of the hygroscopic salt may deteriorate, and when the support time is above the range, an impedance of the electrode increases on the contrary as the hygroscopic salt permeates into the electrode.

In the method for supporting the insulation substrate, to which the positive electrode and the negative electrode are attached, in a coating solution including the hydroscopic salt and ‘drying’ the insulation substrate, the ‘drying’ is for evaporating the solvent staying on the positive electrode, the negative electrode, and the insulation substrate, and may be performed in a method known in the aft to which the present disclosure pertains and the present disclosure is not limited thereto.

<Gas Sensing Method>

The present disclosure may provide a gas sensing method for sensing a sensing target gas by using the gas sensor according to the present disclosure.

In the method for sensing a gas according to the present disclosure, the sensing target gas may be all the gases in the air and all the gases generated in industrial environments, and preferably, may be all the gases that may generate oxidation/reduction reactions, for example, hydrogen, oxygen, nitrogen, chlorine, fluorine, helium, neon, argon, krypton, xenon, radon, sulfuric acid, formaldehyde, methane, butane, propane, carbon dioxide, or a mixture thereof, but the present disclosure is not limited thereto.

According to the present disclosure, the sensing of the gas may be preferably performed at a temperature that is not more than the dew point of a surrounding environment, for example, at a temperature of −20° C. or less. Because the sensing is performed at the temperature or less, the moisture nuclei existing in the surrounding environment are adsorbed by the sensor, a surface of which is coated with the hygroscopic salt and a moisture film is formed on the entire surface of the sensor. If the sensing target gas is adsorbed to the formed moisture film, the concentration of the sensing target gas in the moisture film is amplified and the sensing sensitivity increases.

According to the method for manufacturing a gas sensor and the gas sensing method according to the present disclosure, a low impedance between the electrodes of the sensor may be shown, the gas sensor and the method for manufacturing the gas sensor, by which moisture may be maintained on the surface of the sensor electrode even without using a separate external moisture supply device may be provided, and a method for sensing a gas with a high sensitivity and through reformation without using a high-priced catalyst metal or a high temperature reaction may be provided.

Hereinafter, the present disclosure will be described in detail through embodiments.

However, the embodiments are provided only for understanding of the present disclosure and the scope of the present disclosure is not limited to the embodiments in any meanings.

<Manufacturing Carbon Nano Tube Core and Nano Diamond Shell Nano Structure>

After nano diamond particles of an average diameter of 50 nm were dispersed in distilled water of 100 ml, a substrate in which carbon nano tubes were grown is immersed for 30 minutes to 24 hours so that nano diamond nuclei were bonded to carbon nano tube stems by using static charges of the particles.

Thereafter, a nano structure of a carbon nano tube core-nano diamond shell structure was manufactured by doping boron while growing diamond through a chemical vapor deposition method based on the bonded nano diamond nuclei (see FIG. 3, right picture labeled “b”).

### Embodiment 1—Manufacturing of Gas Sensor

After the manufactured nano structure and a negative electrode material of carbon fibers were attached to the silicon oxide insulation substrate and were supported in a water solution of 0.001 mol/L NaOH for 10 seconds, a surface of the sensor was coated with NaOH by evaporating the solvent at room temperature and room pressure.

### Embodiment 2—Sensing of Ethanol Gas

A ethanol gas was sensed by using the manufactured sensor of embodiment 1 as follows.

A result obtained by an oscilloscope of 500 MHz after a current signal between the negative electrode and the ground point was converted to a voltage by using a resistor of 10 kOhm varistor load while an ethanol gas flows is illustrated in FIG. 4.

As can be seen through FIG. 4, an excellent sensitivity of 0.0135 μA/nM was shown at a concentration of ethanol molecules of 0.5 nM to 10 nM.

Further, a time consumed until the current reaches a peak was less than 1 msec and an accuracy of less than 1% was maintained in the repeated measurement of 200 times.

The gas sensor may show a low impedance between the electrodes of the sensor, the gas sensor, may maintain moisture on the surface of the sensor electrode even without using a separate moisture supply device of the outside may be provided, and may sense a gas with a high sensitivity and through reformation without using a high-priced catalyst metal or a high temperature reaction.

Although the embodiments have been described in detail, it is easily understood by an ordinary person in the art that various modification and corrections may be made without departing from the technical spirit of the present disclosure and the modifications and corrections fall within the scope of the attached claims.

What is claimed is:

1. A gas sensor, comprising:
an insulation substrate; and
a positive electrode and a negative electrode attached to the insulation substrate,
wherein surfaces of the positive electrode and the negative electrode and a surface of a portion of the insulation substrate between the positive electrode and the negative electrode are coated with a hygroscopic salt.

2. The gas sensor of claim 1, wherein the hygroscopic salt includes a hydroxide, a chloride, a bromide, a nitrate, a carbonate, a sulfate, an acetate, or a mixture thereof.

3. The gas sensor of claim 2, wherein the hygroscopic salt is a hydroxide.

4. The gas sensor of claim 1, wherein the positive electrode includes:
a core formed of a carbon-based material; and
a nano structure formed of a nano diamond shell.

5. The gas sensor of claim 4, wherein an average diameter of the nano structure is 10 nm to 500 nm.

6. The gas sensor of claim 4, wherein the nano diamond is p type doped.

7. The gas sensor of claim 4, wherein the nano diamond is doped with one or more doping elements selected from group 3 elements of the periodic table.

8. The gas sensor of claim 7, wherein the nano diamond is doped with one or more doping elements selected from boron, aluminum, gallium, and indium.

9. The gas sensor of claim 8, wherein the nano diamond is doped with boron.

10. The gas sensor of claim 1, wherein the negative electrode is an electrode formed of a gold (Au)-based material, a platinum (Pt)-based material, a metal oxide material, or a carbon-based material.

11. The gas sensor of claim 1, wherein the negative electrode is a carbon-based material.

12. A method for manufacturing a gas sensor, the method comprising:
supporting an insulation substrate, to which a positive electrode and a negative electrode are attached, in a coating solution including a hygroscopic salt and then drying the insulation substrate.

13. The method of claim 12, wherein a concentration of the coating solution including the hygroscopic salt is 0.01 mol/L to 10 mol/L.

14. The method of claim 12, wherein a solvent of the coating solution is distilled water, ethyl alcohol, methyl alcohol, acetone, isopropyl alcohol, butyl alcohol, ethylene glycol, di-ethylene glycol, toluene, or a mixture thereof.

15. The method of claim 12, wherein the support time is 1 second to 60 minutes.

16. A gas sensing method, comprising:
sensing a sensing target gas by using the gas sensor of claim 1.

17. The gas sensing method of claim 16, wherein the sensing target gas is hydrogen, oxygen, nitrogen, chlorine, fluorine, helium, neon, argon, krypton, xenon, radon, sulfuric acid, formaldehyde, methane, butane, propane, carbon dioxide, or a mixture thereof.

18. The gas sensing method of claim 16, wherein the sensing is performed at −20° C. or less.
